(19) United States
(12) Patent Application Publication
(10) Pub. No.: US 2023/0359030 A1
(43) Pub. Date: Nov. 9, 2023

(54) Methods, Apparatuses and Computer Program Products for Remote Fluorophore Illumination in Eye Tracking Systems

(71) Applicant: META PLATFORMS, INC., Menlo Park, CA (US)

(72) Inventors: Francis Lawrence Leard, Sudbury, MA (US); Alfredo Bismuto, Bellevue, WA (US)

(21) Appl. No.: 17/738,566

(22) Filed: May 6, 2022

(51) Int. Cl. G02B 27/01

(52) U.S. Cl. CPC G02B 27/0172; G02B 2027/0138; G02B 2027/0178; G02B 2027/0187

(57) ABSTRACT

A system for eye tracking is disclosed. The system may detect illumination including a first wavelength emitted from one or more illumination sources. The illumination may propagate along a waveguide(s) to a termination node(s) associated with the waveguide(s). The system may detect the illumination propagating a remote fluorophore located at the termination node(s). The system may determine that the remote fluorophore shifted the first wavelength to a second wavelength such that the illumination includes the second wavelength.

### TECHNOLOGICAL FIELD

Exemplary embodiments of this disclosure relate generally to methods, apparatuses, and computer program products for providing remote fluorophore illumination for eye tracking to minimize undesirable stray light in a field of view of a camera(s).

### BACKGROUND

With standard photonic integrated circuit systems in which eye illumination and a camera spectral bandwidth may be the same, there may be a tendency that stray light leakage from waveguides may contaminate an image seen from an eye, thus reducing the contrast ratio of the eye image.

In view of the foregoing drawbacks, it may be beneficial to provide an efficient and reliable mechanism for improving waveguides, coatings and structures to prevent and/or reduce undesirable stray light in a camera’s field of view.

### BRIEF SUMMARY

Exemplary embodiments are described for providing remote phosphor illumination in eye tracking applications to prevent and/or minimize undesirable stray light within a camera’s field of view.

The exemplary embodiments may provide fluorophores such as, for example, Stokes phosphors (e.g., a quantum dot(s) and/or nanocrystal(s), etc.). The Stokes phosphors may be placed at a terminus and at a focus of eye tracking optics (e.g., glint lenses) of glasses (e.g., augmented reality/virtual reality glasses) to move illumination wavelengths out of a user’s vision and may significantly reduce stray light within a camera’s field of view. In some example embodiments, the eye tracking optics may include, but are not limited to, glint lenses which may be utilized to detect glints in a type(s) of eye tracking system(s). Furthermore, by placing the Stokes phosphors at the terminus and at the focus of the eye tracking optics, there may be an increase in the contrast ratio of a glint signal, thereby allowing a faster signal response with lower error incidence.

Some exemplary embodiments may also utilize anti-Stokes phosphors to shift illumination wavelengths to an eye safe region.

In one example embodiment, a device for eye tracking is provided. The device may include at least one camera and one or more illumination sources. The device may further include one or more processors and a memory including computer program code instructions. The memory and computer program code instructions are configured to, with at least one of the processors, cause the device to at least perform operations including detecting illumination comprising a first wavelength emitted from the one or more illumination sources. The illumination may propagate along at least one waveguide to at least one termination node associated with the at least one waveguide. The memory and computer program code are also configured to, with the processor, cause the device to detect the illumination propagating a remote fluorophore located at the at least one termination node. The memory and computer program code are also configured to, with the processor, cause the device to determine that the remote fluorophore shifted the first wavelength to a second wavelength such that the illumination comprises the second wavelength.

In another example embodiment, a method for eye tracking is provided. The method may include detecting illumination comprising a first wavelength emitted from one or more illumination sources. The illumination may propagate along at least one waveguide to at least one termination node associated with the at least one waveguide. The method may further include detecting the illumination propagating a remote fluorophore located at the at least one termination node. The method may further include determining that the remote fluorophore shifted the first wavelength to a second wavelength such that the illumination comprises the second wavelength.

In yet another example embodiment, a computer program product for eye tracking is provided. The computer program product includes at least one computer-readable storage medium having computer-executable program code instructions stored therein. The computer-executable program code instructions may include program code instructions configured to detect illumination comprising a first wavelength emitted from one or more illumination sources. The illumination may propagate along at least one waveguide to at least one termination node associated with the at least one waveguide. The computer program product may further include program code instructions configured to detect the illumination propagating a remote fluorophore located at the at least one termination node. The computer-executable program code instructions may further include program code instructions configured to determine that the remote fluorophore shifted the first wavelength to a second wavelength such that the illumination comprises the second wavelength.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a plan view of a head-mounted display in accordance with an exemplary embodiment.

FIG. 2 is a detailed view of a light projector mounted to a frame of the head-mounted display, taken at dashed circle A of FIG. 1 in accordance with an exemplary embodiment.

FIG. 3 illustrates optical alignment of a projected pattern as viewed by a camera in accordance with an exemplary embodiment.

FIG. 4 is a cross-sectional view of a head-mounted display with alignment cameras in accordance with an exemplary embodiment.

FIG. 5 illustrates an artificial reality system comprising a headset in accordance with an exemplary embodiment.

FIG. 6 is a diagram illustrating a photonics integrated circuit layer associated with a head-mounted display in accordance with an exemplary embodiment.

FIG. 7 is a diagram illustrating cross section detail of a termination node associated with a waveguide in accordance with an exemplary embodiment.

FIG. 8 is a diagram illustrating cross section details of illumination sources emitting illumination associated with a wavelength in accordance with an exemplary embodiment.

FIG. 9 is a diagram of an exemplary process for eye tracking in accordance with an exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, glint(s) or glint image(s) may refer to detection of intended light reflected at an angle from a surface of one or more eyes. As referred to herein, a glint signal may be any point-like response from an eye(s) caused by an energy input. Examples of energy inputs may be any form of time, space, frequency, phase, and/or polarized modulated light or sound. Additionally, glint signals may result from broad area illumination in which the nature of the field of view from a receiving eye tracking system may allow detection of point like responses from surface pixels or volume voxels of an eye(s) (e.g., a combination of an eye detection system with desired artifacts on the surfaces/layers of an eye(s) or within the volume of the eye(s)). This combination of illumination and detection field of views coupled with desired artifacts on the layers/volumes of an eye(s) may result in point like responses from an eye(s), for example, glints.

As referred to herein, a fluorophore(s) may be any particle(s) that fluoresces.

It is to be understood that the methods and systems described herein are not limited to specific methods, specific components, or to particular implementations. It is also to be understood that the terminology used herein is for the purpose of describing particular embodiments only and is not intended to be limiting.

As referred to herein a fluorophore(s) may be any material that takes in photons at a wavelength 1 (also referred to herein as wavelength λ1) and emits photons at a wavelength 2 (also referred to herein as wavelength λ2) with the conversion (e.g., from wavelength λ1 to wavelength λ2) occurring due to quantum energy level shifts with the material of the fluorophore’s physical and/or chemical make-up. In some exemplary embodiments, a fluorophore(s) may be a phosphor, a fluorescent nanocrystal, a fluorescent quantum dot or any other suitable fluorophore(s). The material of a fluorophore(s) may be composed of organic or inorganic compounds.

By the exemplary embodiments placing a remote fluorophore(s) such as a Stokes phosphor (e.g., a remote phosphor), or an anti-Stokes phosphor, in the form of a fluorophore(s) (e.g., a quantum dot (QD), a nanocrystal, etc.) at a terminus of waveguides and at a focus of lenses of a head-mounted display (e.g., glasses), the illumination wavelengths may be moved to a waveband outside of the vision of humans and out of band for a camera such as, for example, a near infrared (NIR) camera, which may be utilized for detection of a glint image. The transport of bluish/ultraviolet (UV) wavelengths may be invisible to the camera, by being out of a spectral range of the camera, and upon striking the remote fluorophore may be converted to a safe wavelength (e.g., 980 nm) for a user’s vision and/or at the point of use may significantly reduce/minimize stray light in a field of view of the camera and may increase a contrast ratio of a glint signal allowing for faster response with lower error incidence.

Since the waveguides may be outside of the keep out zones of lenses, any wavelength in the blue to near infrared band may be utilized by the exemplary embodiments as long as that band is out of the spectral range of the camera. In this regard, blue light wavelengths may be utilized by the exemplary embodiments. In some exemplary embodiments, 780 nanometer (nm) or 840 nm or the like wavelengths generated by illumination sources may be utilized with fluorophores such as for example quantum dots to shift a wavelength to 980 nm, as an example, for illumination emission to detect a glint image.

Some exemplary embodiments may utilize anti-Stokes fluorophores (e.g., anti-Stokes phosphors) which may allow an illumination wavelength to be shifted to any wavelength greater than 1250 nm (e.g., an eye safe region) while still allowing for the illumination wavelength emission for detecting a glint image to be in the 980 nm band that a camera may view without any potential eye safety issues.

A Stokes fluorophore (also referred to herein as Stokes phosphor) may absorb radiation (e.g., in the form of photons) at a wavelength such as, for example, wavelength λ1 and may emit a lower energy (e.g., longer wavelength) at a wavelength such as, for example, wavelength λ2. This may, for example, be enacted by the material of the Stokes fluorophore by way of a quantum mechanical exchange due to an incoming photon (e.g., an excitation source) causing a lower bound electron to rise to a higher energy state which may have a fast decay time to a lower energy state that may not be a ground state and as such may emit a lower energy (e.g., longer wavelength (e.g., wavelength λ2)).

Some exemplary embodiments may utilize anti-Stokes fluorophores. An anti-Stokes fluorophore may be similar to a Stokes fluorophore in energy states, but the anti-Stokes fluorophore may include a series of subbands or defect bands going from a lower energy state to a higher energy state. Each of the subbands may have a long decay time such that energy within an eye tracking system (e.g., a head-mounted display having an eye tracking camera) may build up by absorbing photons of lower energy at a wavelength such as, for example, a wavelength λ3. In an instance in which electrons attain enough energy to pass into the higher energy state, which may also have a short decay time with a direct path to an energy state lower than where the electrons first started, this electron state may emit a photon at a shorter wavelength such as, for example, wavelength λ2. In some exemplary embodiments, wavelength λ2 may be a desired wavelength for eye tracking systems/applications.

As described more fully below, by utilizing Stokes fluorophores and/or anti-Stokes fluorophores, a source illumination such as, for example, light having a wavelength λ1 and/or wavelength λ3 may not be detected by an eye tracking camera because this source illumination may be either filtered out by optical wavelength filters in front of a photodetection surface associated with the eye tracking camera or may be above an absorption spectral band or below the absorption spectral band of detector elements associated with the eye tracking camera. As such, the signal to noise ratio and/or the contrast ratio of the eye tracking camera may be improved due to a lack of ambient noise being present in eye tracking systems that emit and detect source illumination having wavelength λ1 and/or wavelength λ3.

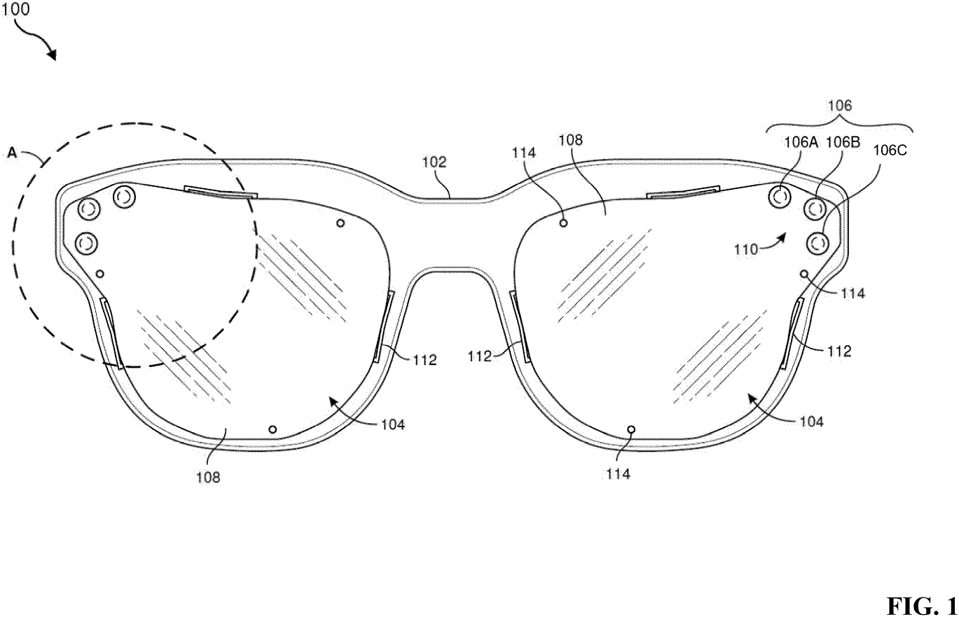

FIG. 1 illustrates an example head-mounted display 100 associated with artificial reality content. The head-mounted display 100 may include an enclosure 102 and a display assembly 104 coupled to the enclosure 102. The display assembly 104 for side of the head-mounted display 100 may include a light projector 106 (shown in dashed lines in FIG. 1) and a waveguide 108 configured to direct images (e.g., glint images) from the light projector 106 to a user’s eye. In some examples, the light projector 106 may include three sub-projectors 106A, 106B, and 106C that are configured to project light of different wavelengths (e.g., colors, such as red, green, and/or blue). The waveguide 108 may include at least one input grating 110 positioned adjacent to the light projector 106. The input grating 110 may be configured to enable light from the light projector 106 to enter into the waveguide 108, to be directed to the center of the waveguide 108 for presentation to the user’s eye. For example, as shown in FIG. 1, the input grating 110 may include three optical apertures respectively aligned with the three sub-projectors 106A, 106B, and 106C of the light projector 106.

In some examples, the head-mounted display 100 may be implemented in the form of augmented-reality glasses. Accordingly, the waveguide 108 may be at least partially transparent to visible light to allow the user to view a real-world environment through the waveguide 108.

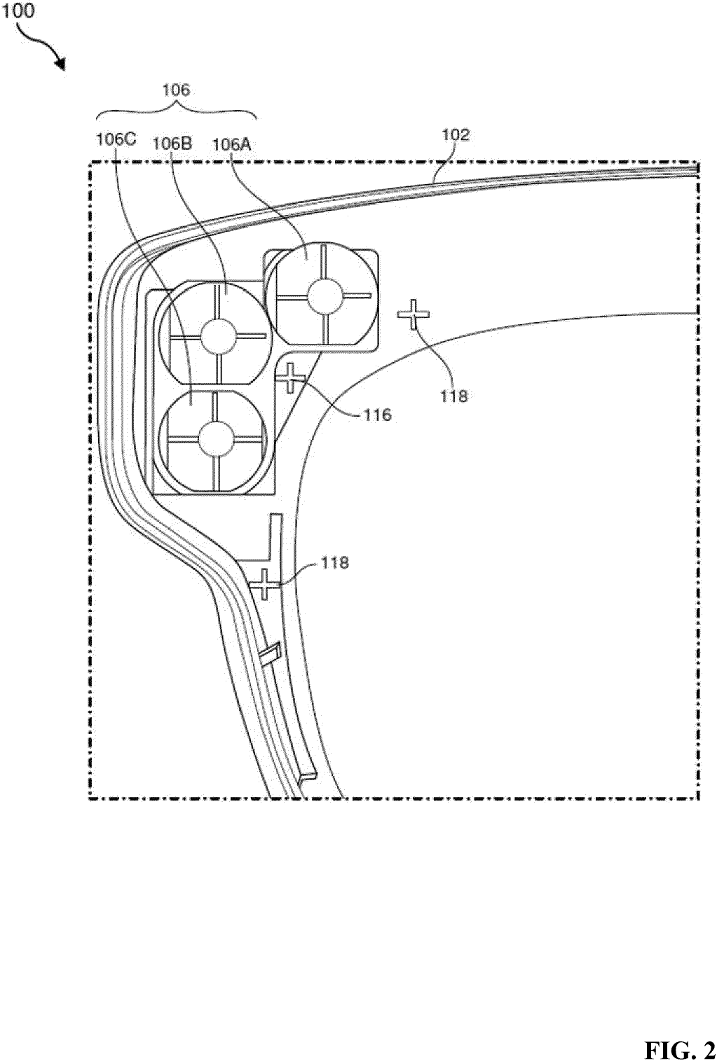

FIG. 2 illustrates the light projector 106 of the head-mounted display 100 shown in the dashed circle A of FIG. 1. The waveguide 108 is not shown in FIG. 2, to more clearly show underlying features of the head-mounted display 100. As shown in FIG. 2, the light projector 106 may be mounted on the enclosure 102 of the head-mounted display 100, such as in an upper corner of the enclosure 102. The first subprojector 106A may include a blue light source, the second subprojector 106B may include a red light source, and the third subprojector 106C may include a green light source. Other colors and arrangements of the subprojectors 106A, 106B, and 106C may also be possible.

To assemble the head-mounted display 100, the three subprojectors 106A, 106B, and 106C may be initially assembled with each other (e.g., three light sources mounted to a common substrate, three collimating lenses aligned on the three light sources) to form the light projector 106 as a unit. The light projector 106 may include one or more projector fiducial marks 116, which may be used in optically aligning (e.g., positioning, orienting, securing) the light projector 106 with the enclosure 102. In some examples, the enclosure 102 may likewise include one or more frame fiducial marks 118 to assist in the optical alignment of the light projector 106 with the enclosure 102.

Optical alignment of the light projector 106 relative to the enclosure 102 may involve viewing the light projector 106 and/or enclosure 102 during placement of the light projector 106 in or on the enclosure 102 with one or more cameras, which may be used to identify the location and orientation of the projector fiducial mark(s) 116 relative to the location and orientation of the frame fiducial mark(s) 118. The projector fiducial mark(s) 116 on both sides of the enclosure 102 may be used to balance the frame into a computer aided design (CAD)-nominal position. The projector fiducial mark(s) 116 and the enclosure fiducial mark(s) 118 are each shown in FIG. 2 in the shape of a plus sign. However, other shapes, physical features (e.g., of the light projector 106 and/or of the enclosure 102), reflective surfaces, or other optical identifiers may be used to optically align the light projector 106 relative to the enclosure 102.

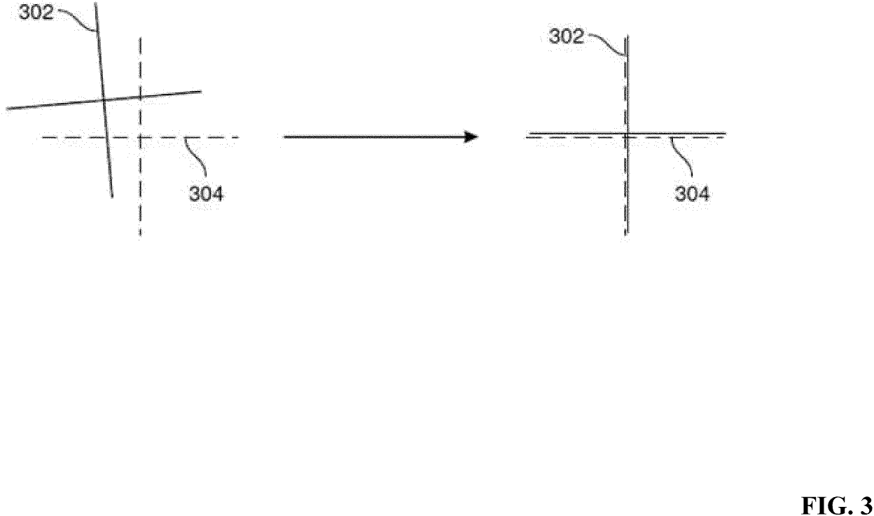

FIG. 3 illustrates optical alignment of a projected pattern 302 as viewed by a camera. In some embodiments, the light projector 106 may be aligned relative to the frame 102 using an image (e.g., a glint image) projected by the light projector 106. The projected pattern 302 may be a cross or another pattern. The projected pattern 302 may be aligned with a camera target 304. The camera target 304 may be an area identified using computer vision (CV) to identify a center of the projected pattern 302 (e.g., the intersection of two lines if the projected pattern 302 is a cross). The camera may be calibrated to a global-equipment coordinate system such that the mechanical and optical position of the camera target 304 is optimized. The light projector 106 may be physically manipulated to align to the detected center of the projected pattern 302 (e.g., the camera target 304). The projected pattern 302 may be produced by a light projector, such as the light projector 106 described above. One or more cameras may view the projected pattern 302 and compare the location and orientation of the projected pattern 302 to the camera target 304. The light projector and/or a frame to which the light projector is to be mounted may be moved (e.g., laterally shifted, angled, rotated, etc.) to align the projected pattern 302 with the camera target 304 to an acceptable resolve (e.g., within an acceptable tolerance) before the light projector is fixed in position relative to the frame. An acceptable tolerance may be, for example, within 2 arcminutes (arcmin) between the projected pattern 302 and the camera target. Other acceptable tolerances (e.g., 3 arcmin, etc.) between the projected pattern 302 and the camera target may be possible.

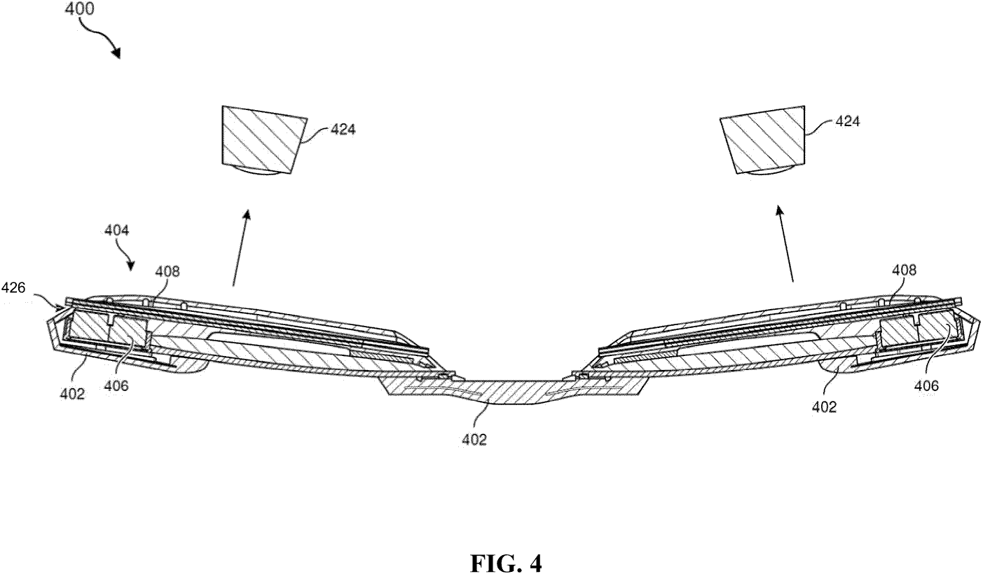

FIG. 4 is a cross-sectional view of a head-mounted display 400 with alignment cameras 424. In at least some respects, the head-mounted display 400 may be similar to the head-mounted display 100 described above. For example, the head-mounted display 400 may include a frame 402, and a display assembly 404 including a light projector 406 and a waveguide 408 mounted to the frame 402.

The alignment cameras 424 may be used during assembly of the head-mounted display 400 to optically align the light projector 406 with the frame 402 and/or to optically align the waveguide 408 with the light projector 406. For example, the alignment cameras 424 may be used to detect the location and/or orientation of a fiducial mark (e.g., the projector fiducial marks 116, the frame fiducial marks 118, etc.), a physical component or feature, a reflective material, etc. In additional examples, the alignment cameras 424 may be used to detect a location and/or orientation of a projected pattern (e.g., the projected pattern 302). This detected information may be used to adjust a position and/or orientation of the light projector 406 relative to the frame 402 or of the waveguide 408 relative to the light projector 406 and/or frame 402.

As shown in FIG. 4, a gap 426 may be between the waveguide 408 and the light projector 406. Thus, in some embodiments, the waveguide 408 and the light projector 406 may not be directly coupled to each other. Rather, the light projector 406 and the waveguide 408 may each be separately mounted to the frame 402. This may allow for adjustments in relative position and/or orientation between the light projector 406 and the waveguide 408.

The frame 402 and the light projector 406 may be used substantially aligned. For example, the frame 402 and the light projector 406 may be aligned such that, when viewed by a camera, a projected pattern produced by a light projector 406 and a camera target (e.g., projected pattern 302 and camera target 304 in FIG. 3) are within an acceptable tolerance (e.g., 2 arcmin, 3 arcmin, etc.).

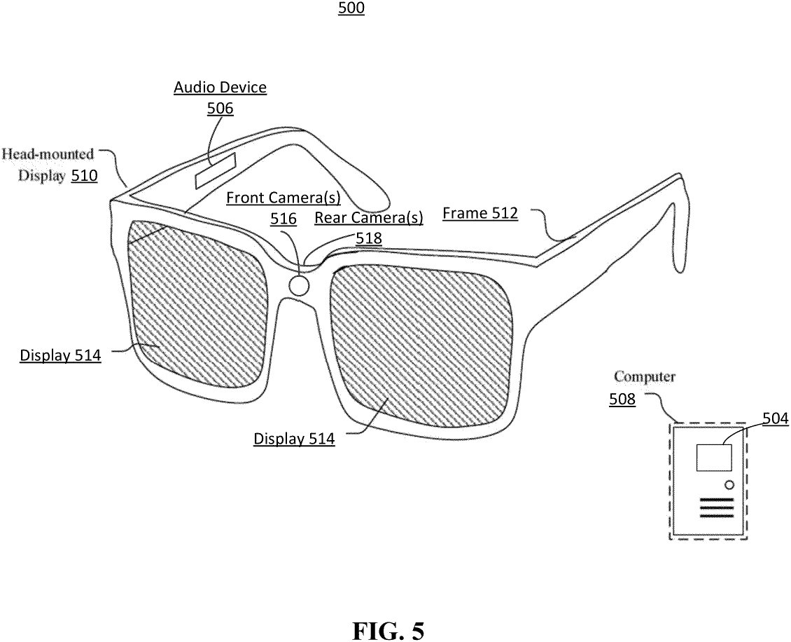

FIG. 5 illustrates an example artificial reality system 500. The artificial reality system 500 may include a head-mounted display (HMD) 510 (e.g., smart glasses) comprising a frame 512, one or more displays 514, and a computing device 508 (also referred to herein as computer 508). The displays 514 may be transparent or translucent allowing a user wearing the HMD 510 to look through the displays 514 to see the real world (e.g., real world environment) and displaying visual artificial reality content to the user at the same time. The HMD 510 may include an audio device 506 (e.g., speakers/microphones) that may provide audio artificial reality content to users. The HMD 510 may include one or more cameras 516, 518 which may capture images and/or videos of environments. In one exemplary embodiment, the HMD 510 may include a camera(s) 518 which may be a rear-facing camera tracking movement and/or gaze of a user’s eyes.

One of the cameras 516 may be a forward-facing camera capturing images and/or videos of the environment that a user wearing the HMD 510 may view. The HMD 510 may include an eye tracking system to track the vergence movement of the user wearing the HMD 510. In one exemplary embodiment, the camera(s) 518 may be the eye tracking system. In some exemplary embodiments, the camera(s) 518 may be one camera configured to view at least one eye of a user to capture a glint image(s) (e.g., and/or glint signals). In some other exemplary embodiments, the camera(s) 518 may include multiple cameras viewing each of the eyes of a user to enhance the capture of a glint image(s) (e.g., and/or glint signals). The HMD 510 may include a microphone of the audio device 506 to capture voice input from the user. The augmented reality system 500 may further include a controller 504 comprising a trackpad and one or more buttons. The controller 504 may receive inputs from users and relay the inputs to the computing device 508. The controller may also provide haptic feedback to one or more users. The computing device 508 may be connected to the HMD 510 and the controller through cables or wireless connections. The computing device 508 may control the HMD 510 and the controller to provide the augmented reality content to and receive inputs from one or more users. In some example embodiments, the controller 504 may be a standalone controller or integrated within the HMD 510. The computing device 508 may be a standalone host computer device, an on-board computer device integrated with the HMD 510, a mobile device, or any other hardware platform capable of providing artificial reality content to and receiving inputs from users. In some exemplary embodiments, HMD 510 may include an artificial reality system/virtual reality system.

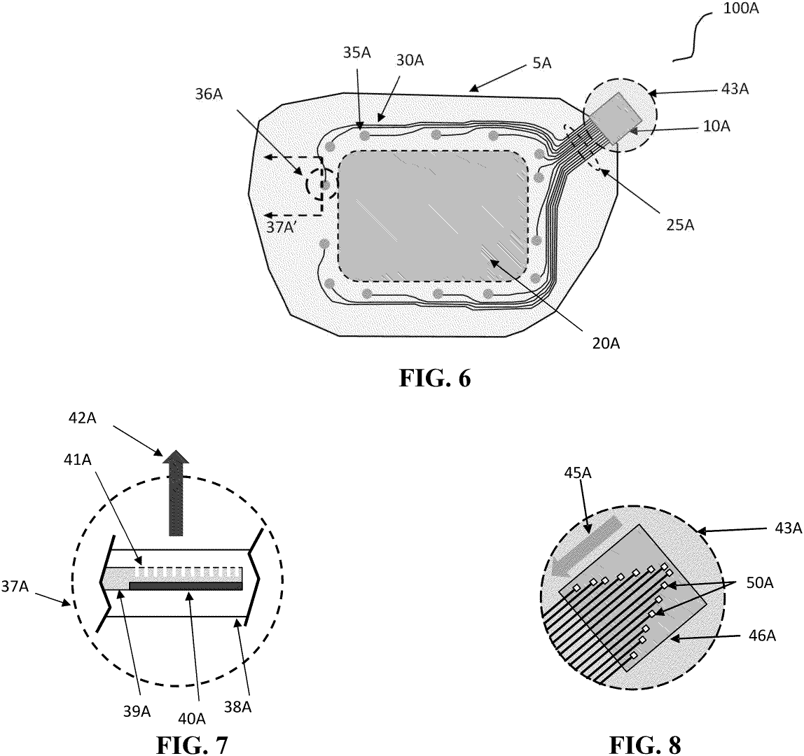

Referring now to FIG. 6, a diagram illustrating a photonics integrated circuit (PIC) layer of a display (e.g., lenses) associated with a head-mounted display (e.g., smart glasses) is provided according to an exemplary embodiment. The display (e.g., lenses), associated with the photonics integrated circuit layer may be associated with the display 514. In one exemplary embodiment, the head-mounted display may be HMD 510 (e.g., smart glasses). In the example of FIG. 6, the PIC layer 100A may include a remote fluorophore illumination system for eye tracking applications. The PIC layer 100A may include a PIC layer 5A that incorporates remote fluorophores. The PIC layer 100A may include an exemplary cross section 43A, which illustrates details of components for emitting light associated with a wavelength(s). For example, cross section 43A may illustrate details associated with illumination sources configured to illuminate/emit light associated with a wavelength such as, for example, wavelength λ1 or other suitable wavelengths. As shown in FIG. 6, the PIC layer 100A may also include a source illumination carrier 10A. The source illumination carrier 46A of FIG. 8 illustrates an expanded view of the source illumination carrier 10A which includes the illumination sources 50A (e.g., light projector 106, light projector 406). Further, the PIC layer 100A may include a keep-out region 20A dedicated to augmented reality/virtual reality display presentation. The PIC layer 100A may include an exemplary array of PIC waveguides 25A. The array of PIC waveguides 25A may be configured to transport source illumination (e.g., at wavelength λ1) from the source illumination carrier 10A to an emission port(s) (e.g., a termination node 35A, a termination node 36A). As an example, PIC waveguide 30A (e.g., waveguide 108, waveguide 408) may be one of the PIC waveguides 25A utilized to carry/transport source illumination (e.g., at wavelength λ1). Termination node 35A may be a termination node of a PIC waveguide carrying illumination (e.g., at wavelength λ1). Termination node 36A may be another termination node of another PIC waveguide carrying illumination (e.g., at wavelength λ1). The cross section 37A′ may be a cut through view of termination node 36A which is shown more fully in cross section 37A of FIG. 7.

Referring now to FIG. 7, a diagram illustrating cross section detail of a termination node associated with a photonics integrated circuit waveguide is provided in accordance with an exemplary embodiment. In the example of FIG. 7, the cross section detail 37A may be a cross section associated with termination node 36A of a PIC waveguide (e.g., PIC waveguide 30A). The cross section 37A associated with termination node 36A also illustrates cross section 38A details of the PIC layer 5A that includes remote fluorophores. FIG. 7 also illustrates cross section 39A detailing the cross section of PIC waveguide 30A configured to carry/transport an illumination source (e.g., at wavelength λ1). A remote fluorophore 40A, is shown in FIG. 7, located along the cross section 39A at the termination node 36A. The remote fluorophore 40A may absorb illumination (e.g., light) such as, for example, at a wavelength λ1 and may emit illumination such as, for example, at a wavelength λ2.

The output coupler 41A of FIG. 7 may be configured to react to light having wavelength λ2 and direct it out of the PIC waveguide 30A normal to the surface of the PIC layer 5A at termination node 36A. The output coupler 41A may be a surface relief grating, a volume hologram, a polarization volume hologram, a diffractive optical element, a meta-antenna, an excitonic or plasmonic circuit or other resonance-based structure that may react to the wavelength λ2 to extract light associated with wavelength λ2 from PIC waveguide 30A and directing the associated light normal to PIC layer 5A along the path 42A. The output coupler 41A may modify the spatial and/or angular profile of path 42A based on the design of output coupler 41A.

In the example of FIG. 7, the output coupler 41A may facilitate/cause termination node emission 42A associated with termination node 36A pertaining to PIC waveguide 30A. The output coupler 41A may shape the termination node emission 42A and the termination node emission 42A may emit light associated with wavelength λ2 from PIC waveguide 30A and may emit the light towards an eye(s) of a user to be utilized as an eye tracking beam.

Referring to FIG. 8, a diagram illustrating cross section details of illumination sources emitting light associated with a wavelength is provided according to an exemplary embodiment. In the example of FIG. 8, the cross section 43A may illustrate details associated with illumination sources 50A configured to emit light associated with a wavelength such as, for example, wavelength λ1 and/or other suitable wavelengths. The light may be emitted by the illumination sources 50A according to a direction 45A associated with wavelength λ1, for example, within each of the PIC waveguides of the array of PIC waveguides 25A. The source illumination carrier 46A may illustrate an expanded view of the source illumination carrier 10A, in FIG. 6, which may include illumination sources 50A each emitting light associated with a wavelength λ1, or other suitable wavelengths, for example. In this regard, illumination sources 50A may be sources of emitting light having a wavelength λ1, for example. In some example embodiments, the illumination sources 50A may, for example, be light emitting diodes (LEDs) and/or lasers. The lasers may, for example, be vertical cavity surface emitting lasers (VCSELs), stripe guide lasers, and/or wavelength/polarization stabilized grating lasers.

In some exemplary embodiments, the PIC layer 100A may be embodied within, or associated with, a head-mounted display (e.g., HMD 510) which may include an eye tracking system to track the vergence movement of a user wearing the HMD. In one exemplary embodiment, a camera (e.g., camera(s) 518) may be the eye tracking system. For example, the camera (e.g., camera(s) 518) may track movement and/or gaze of a user’s eyes. Consider for example, an instance in which the camera is tracking one or more eyes of a user. In this regard, the illumination sources 50A (e.g., LEDs, lasers) may emit light to be directed towards an eye(s) in which the light may be utilized as an eye tracking beam. Consider, for example, that the light emitted by one or more of the illumination sources 50A has a wavelength λ1. In some example embodiments, for purposes of illustration and not of limitation, a wavelength associated with wavelength λ1 may, but need not, be 460 nm. Other suitable examples of wavelength λ1 (e.g., 780 nm, 840 nm) may be possible in some exemplary embodiments. In some examples, one or more of the illumination sources 50A may emit in a blue/ultraviolet visible spectrum and/or in a near infrared visible spectrum. In an instance in which anti-Stokes phosphors are utilized, the anti-Stokes phosphors may allow an illumination wavelength to be shifted to any wavelength (e.g., wavelength λ3) greater than 1250 nm (e.g., an eye safe region) while still allowing for the illumination wavelength emission for detecting a glint image to be in the 980 nm band (e.g., wavelength λ2) that a camera may view without any potential eye safety issues. A remote fluorophore (e.g., remote fluorophore 40A) located at a PIC waveguide (e.g., PIC waveguide 30A) may convert the wavelength λ1 to a desired wavelength that may be beneficial for eye tracking, as described more fully below.

For example, the illumination sources 50A, of the source illumination carrier 10A, may be configured to facilitate emission of light into a PIC waveguide such as, for example, PIC waveguide 30A. The light (e.g., an illumination source having wavelength λ1) may travel/propagate to a termination node (e.g., termination node 36A, termination node 35A) of the PIC waveguide. For example, the light may travel/propagate to the termination node 36A. As shown in the cross section 37A, of FIG. 7, detailing the termination node 36A, the light may travel along the PIC waveguide 30A (see e.g., cross section 39A) and to the remote fluorophore 40A of the PIC waveguide 30A which may absorb the light having wavelength λ1 (e.g., 460 nm) and may emit light having wavelength λ2. In this example, a wavelength associated with wavelength λ2 may, but need not, be 980 nm. In this regard, the remote fluorophore 40A may convert/shift the light from wavelength λ1 (e.g., 460 nm) to a wavelength λ2 (e.g., 980 nm) which may be a wavelength region safe for an eye(s) of a user and may be a wavelength region capable of detection by the camera (e.g., camera(s) 518). As such, even in an instance in which there may be stray light leakage from a PIC waveguide (e.g., PIC waveguide 30A), the camera (e.g., camera(s) 518) may not see/view the light because the light may not be in the visible spectra that the camera is capable of detecting.

In the above example, the remote fluorophore 40A (e.g., a Stokes fluorophore (e.g., a quantum dot)) may absorb radiation (e.g., in the form of photons) at a wavelength such as, for example, wavelength λ1 (e.g., 460 nm) and may emit a lower energy (e.g., longer wavelength) at a wavelength such as, for example, wavelength λ2 (e.g., 980 nm). This may, for example, be enacted in the material of the remote fluorophore (e.g., a Stokes fluorophore) by way of a quantum mechanical exchange due to an incoming photon (e.g., an excitation source) causing a lower bound electron to rise to a higher energy state which may have a fast decay time to a lower energy state that may not be a ground state and as such may emit a lower energy (e.g., longer wavelength). In some example embodiments, the wavelength selectivity associated with an excitation wavelength (e.g., 460 nm, etc.) may be attained by structuring a quantum dot (e.g., resonant coatings), and/or adding compounds that may negate the effects of undesired wavelengths such as, for example, minimizing defects and traps associated with an electronic structure of the quantum dot to negate undesired wavelengths. The size of the quantum dot may determine emission wavelengths such as the desired emission wavelength (e.g., 980 nm). The defects and traps, described above, may be electronic and/or quantum mechanical structures within a material (e.g., a quantum dot). Defects and traps may cause a change in transition of an excited electron/hole to reach a ground state. In some instances, defects and/or traps may be initially created to alter the time or energy level of an excited electron(s) on its way to ground (e.g., neutral) state. As an example pertaining to lasers, a stimulated emission may be caused by a trap that is initially put into a quantum mechanical structure of the lasing media by the addition of dopant materials that may perturb the energy states to form a trap(s). The electrons that are excited may get trapped in this state until a threshold is reached and in which case the trap level is released all at once thus producing an inversion situation and may allow the material to lase. In examples such as fluorescent materials (e.g., a quantum dot), a defect may cause a change in an emission wavelength with some of the energy going into heat in a matrix (e.g., associated with phonons or long wave photons).

In response to the remote fluorophore 40A converting/shifting the light from wavelength λ1 (e.g., 460 nm) to wavelength λ2 (e.g., 940 nm), the output coupler 41 may react to the light having wavelength λ2 and may direct the light out of the PIC waveguide (e.g., PIC waveguide 30A) along a termination node emission 42 path normal to a surface of the PIC layer 5A at a termination node (e.g., termination node 36A). The termination node emission 42A may shape the light having wavelength λ2 from the output coupler 41 and may emit the light having wavelength λ2 towards an eye(s) of a user (e.g., a user wearing HMD 510) as an eye tracking beam. In this example, the termination node emission 42A may be associated with light having wavelength λ2 (e.g., 960 nm), whereas the light from one or more illumination sources 50A may be associated with wavelength λ1 (e.g., 460 nm). For purposes of illustration and not of limitation, the camera (e.g., camera(s) 518) associated with the HMD may be only capable of detecting light associated with wavelength λ2 (e.g., an eye safe wavelength). In other words, the light associated with wavelength λ1 emitted by one or more of the illumination sources 50A may be invisible (e.g., undetectable) to the camera. The camera may be unable to detect any light having a wavelength band that is outside of the spectral range of the camera. As such, even in an instance in which stray light having wavelength λ1 may leak from a PIC waveguide (e.g., PIC waveguide 30A), the stray light may be undetectable by the camera because it may be outside of the spectral range of the camera. Since the stray light may be outside of the spectral range of the camera, the stray light may not degrade a signal to noise ratio (SNR) and/or a contrast ratio associated with the camera. Furthermore, as described above, the light having wavelength λ2 that is directed, by the termination node emission 42A, to an eye(s) of a user as an eye tracking beam may be safe for eyes.

In some alternative exemplary embodiments, the remote fluorophore 40A may be a remote phosphor such as an anti-Stokes phosphor which may allow light emitted from one or more illumination sources 50A at a wavelength λ3 or greater (e.g., greater than 1250 nm) to be shifted by the remote fluorophore 40A, in the PIC waveguide at a termination node, to be in the wavelength λ1 band (e.g., 980 nm) that the camera (e.g., camera 518) may be able to detect. The wavelength λ3 may be in an eye safe region. The remote fluorophore 40A as an anti-Stokes phosphor may be in the PIC waveguide (e.g., PIC waveguide 30A) at a termination node (e.g., termination node 36A, termination node 35A) in a same manner as described above regarding a Stokes phosphor as the remote fluorophore 40A.

The anti-Stokes phosphor may be similar to the Stokes phosphor in energy states, but the anti-Stokes phosphor may include a series of subbands or defect bands going from a lower energy state to a higher energy state. Each of the subbands may have a long decay time such that energy within an eye tracking system (e.g., HMD 510) may build up by absorbing photons of lower energy at wavelength λ3. In an instance in which electrons attain enough energy to pass into the higher energy state, which also may have a short decay time with a direct path to an energy state lower than where the electrons first started, that electron state may emit a photon at wavelength λ2 (e.g., a shorter wavelength) and wavelength λ2 may be a desired wavelength for eye tracking associated with the camera (e.g., camera(s) 518). The illumination (e.g., light) emitted from the illumination sources 50A having wavelength λ1 and wavelength λ3 may not be detectable by the camera since these wavelengths may be outside of the spectral range of the camera (e.g., camera(s) 518). As such, the signal to noise ratio and/or the contrast ratio of the camera (e.g., camera(s) 518) may be improved due to a lack of ambient noise being present in the camera and/or associated with an HMD as an eye tracking system.

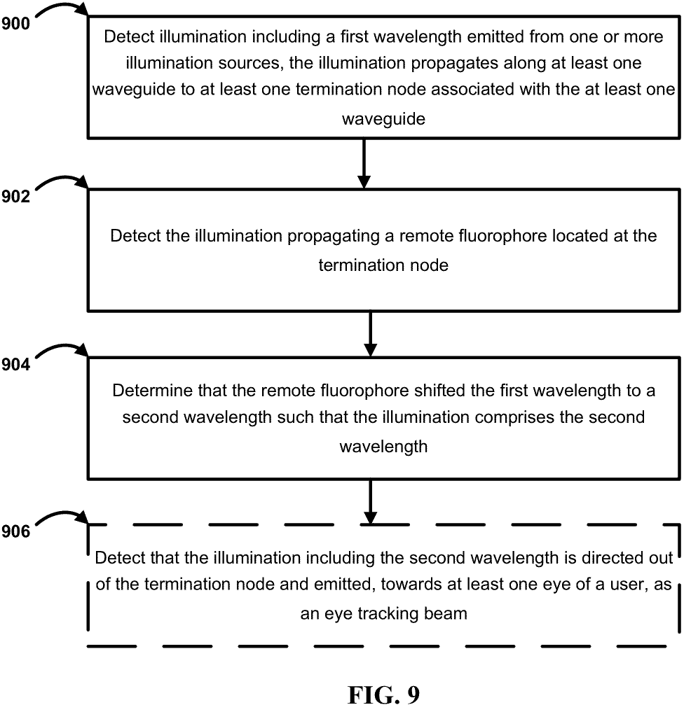

FIG. 9 illustrates an example flowchart illustrating operations for eye tracking according to an exemplary embodiment. At operation 900, a device (e.g., HMD 510) may detect illumination (e.g., light) including a first wavelength (e.g., wavelength λ1) emitted from one or more illumination sources (e.g., illumination sources 50A). The illumination may propagate along at least one waveguide (e.g., PIC waveguide 30A) to at least one termination node (e.g., termination node 36A, termination node 35A, etc.) associated with the at least one waveguide.

At operation 902, a device (e.g., HMD 510) may detect the illumination propagating a remote fluorophore (e.g., remote fluorophore 40A) located at the termination node. At operation 904, a device (e.g., HMD 510) may determine that the remote fluorophore shifted the first wavelength (e.g., wavelength λ1) to a second wavelength (e.g., wavelength λ2) such that the illumination comprises the second wavelength.

Optionally at operation 904, a device (e.g., HMD 510) may detect that the illumination comprising the second wavelength is directed out of the termination node and emitted, towards at least one eye of a user, as an eye tracking beam. The illumination comprising the second wavelength may be directed out of the termination node by an output coupler (e.g., output coupler 41A) based on a termination node emission (e.g., termination node emission 42A). The illumination comprising the second wavelength (e.g., 980 nm) may be safe for the at least one eye of the user. The first wavelength (e.g., 460 nm) may be harmful to the at least one eye of the user.

The device (e.g., HMD 510) may include at least one photonics integrated circuit layer (e.g., PIC layer 100A) including a plurality (e.g., an array) of PIC waveguides (e.g., PIC waveguides 25A) configured to transport the illumination including the first wavelength or other illumination comprising a third wavelength (e.g., wavelength λ3). The device (e.g., HMD 510) may determine that the remote fluorophore (e.g., remote fluorophore 40A) shifted the third wavelength (e.g., wavelength λ3 (e.g., greater than 1250 nm)) to the second wavelength (e.g., wavelength λ2 (e.g., 980 nm)) such that the other illumination comprises the second wavelength.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A device comprising:
at least one camera;
one or more illumination sources; and
at least one processor and a non-transitory memory including computer-executable instructions, which when executed by the processor, cause the device to at least:
detect illumination comprising a first wavelength emitted from the one or more illumination sources, wherein the illumination propagates along at least one waveguide to at least one termination node associated with the at least one waveguide;
detect the illumination propagating a remote fluorophore located at the at least one termination node; and
determine that the remote fluorophore shifted the first wavelength to a second wavelength such that the illumination comprises the second wavelength.

2. The device of claim 1, wherein the instructions, when executed by the processor, further cause the device to:
detect that the illumination comprising the second wavelength is directed out of the termination node and emitted, towards at least one eye of a user, as an eye tracking beam.

3. The device of claim 1, wherein the remote fluorophore comprises a Stokes phosphor.

4. The device of claim 1, wherein the illumination comprising the second wavelength is safe for the at least one eye of the user.

5. The device of claim 1, wherein the second wavelength comprises a wavelength longer than a wavelength associated with the first wavelength.

6. The device of claim 1, wherein the remote fluorophore comprises at least one of a phosphor, a nanocrystal or a quantum dot.

7. The device of claim 1, wherein the illumination comprising the first wavelength is undetectable by the at least one camera.

8. The device of claim 1, further comprising:
at least one photonics integrated circuit layer comprising a plurality of photonic integrated circuit waveguides configured to transport the illumination comprising the first wavelength or other illumination comprising a third wavelength.

9. The device of claim 8, wherein the instructions, when executed by the processor, further cause the device to:
determine that the remote fluorophore shifted the third wavelength to the second wavelength such that the other illumination comprises the second wavelength.

10. The device of claim 9, wherein the remote fluorophore comprises an anti-Stokes phosphor.

11. The device of claim 9, wherein the third wavelength comprises a wavelength longer than a wavelength associated with the second wavelength.

12. A method comprising:
detecting illumination comprising a first wavelength emitted from one or more illumination sources, wherein the illumination propagates along at least one waveguide to at least one termination node associated with the at least one waveguide;
detecting the illumination propagating a remote fluorophore located at the at least one termination node; and
determining that the remote fluorophore shifted the first wavelength to a second wavelength such that the illumination comprises the second wavelength.

13. The method of claim 12, further comprising:
detecting that the illumination comprising the second wavelength is directed out of the termination node and emitted, towards at least one eye of a user, as an eye tracking beam.

14. The method of claim 12, wherein the remote fluorophore comprises a Stokes phosphor.

15. The method of claim 12, wherein the illumination comprising the second wavelength is safe for the at least one eye of the user.

16. The method of claim 12, wherein the first wavelength is harmful to the at least one eye of the user.

17. The method of claim 12, wherein the second wavelength comprises a wavelength longer than a wavelength associated with the first wavelength.

18. The method of claim 12, wherein the remote fluorophore comprises at least one of a phosphor, a nanocrystal or a quantum dot.

19. A computer-readable medium storing instructions that, when executed, cause:
detecting illumination comprising a first wavelength emitted from one or more illumination sources, wherein the illumination propagates along at least one waveguide to at least one termination node associated with the at least one waveguide;
detecting the illumination propagating a remote fluorophore located at the at least one termination node; and
determining that the remote fluorophore shifted the first wavelength to a second wavelength such that the illumination comprises the second wavelength.

20. The computer-readable medium of claim 19, wherein the instructions, when
executed, further cause:
detecting that the illumination comprising the second wavelength is directed out of the termination node and emitted, towards at least one eye of a user, as an eye tracking beam.
